(19) United States
(12) Patent Application Publication
(10) Pub. No.: US 2024/0286225 A1
(43) Pub. Date: Aug. 29, 2024

(54) PROCESSING METHOD OF BRITTLE MATERIAL

(71) Applicant: SHENZHEN JIXIANGYUN TECHNOLOGY CO., LTD., SHENZHEN (CN)

(72) Inventors: ZAIFU HUANG, SHENZHEN (CN); YAN CHEN, SHENZHEN (CN); YIWEN GU, SHENZHEN (CN); YONG ZHANG, SHENZHEN (CN); LIN YANG, SHENZHEN (CN)

(21) Appl. No.: 18/659,007

(22) Filed: May 9, 2024

Related U.S. Application Data
(63) Continuation of application No. PCT/CN2022/094893, filed on May 25, 2022.

(30) Foreign Application Priority Data
Sep. 30, 2021 (CN) 202111169144.6

(51) Int. Cl. B23K 26/382; B23K 26/0622; B23K 26/402; B23K 26/70; B23K 103/00

(52) U.S. Cl. CPC B23K 26/382; B23K 26/0624; B23K 26/402; B23K 26/703; B23K 2103/54

(57) ABSTRACT

A processing method of a brittle material is provided, which includes: cutting a contour line of a preset standard hole and a plurality of breaking guide line groups located within the contour line on a workpiece by a first laser, one end of a breaking guide line of the breaking guide line groups being connected with the contour line and the other end of the breaking guide line extending within the contour line; heating and pre-breaking the contour line and the breaking guide line on the workpiece by a second laser; processing a blanking hole within the contour line on the workpiece by a non-thermal processing, the extended end of the breaking guide line extending into the blanking hole; and breaking along the contour line and the breaking guide line on the workpiece to form a standard hole in the workpiece.

### TECHNICAL FIELD

The present disclosure relates to the technical field of brittle material processing, in particular to a processing method of a brittle material.

### BACKGROUND

With development and progress of society, production technologies are constantly updated and upgraded, and processing of holes (such as round holes and irregular-shaped holes (including square holes)) on a brittle material (such as glass and other high-hardness brittle materials) has gradually converted original mechanical cutting into laser cutting, which greatly improves processing efficiency.

At present, a laser processing method of a hole structure in a brittle sheet is disclosed in a Chinese patent application No. 202110524042.5. In this laser processing method, first, a blanking hole is carved in the brittle sheet by using a first laser, so that brittle materials in the blanking hole are blanked; then, a trajectory line of a standard hole is cut in the brittle sheet by using a second laser, and a breaking guide line is cut in a breaking area; and finally, the breaking area is split along the trajectory line of the standard hole and the breaking guide line to form the standard hole of the brittle sheet.

In the laser processing method, because an edge of the blanking hole carved by the first laser has chipping (which refers to phenomenon of unevenness, curling, burrs or the like in a cutting surface of a sheet during a cutting process of the sheet due to reasons of the sheet itself and influence of a cutting tool and a cutting speed), the breaking guide line actually cut by the second laser in the breaking area will not match a preset breaking guide line, which may result in that the breaking guide line can't intersect and be connected with the trajectory line of the standard hole previously formed by cutting, and because a size of the breaking area between the trajectory line of the standard hole and the blanking hole is small with stress relatively concentrated, when laser breaking is performed, the breaking guide line is prone to be cracked outside the trajectory line of the standard hole, resulting in breaking failure and low product processing success rate.

### SUMMARY

A main purpose of the present disclosure is to provide a processing method of a brittle material, aiming at solving a technical problem of low success rate in a processing method for a hole structure in the brittle material in related art. In order to achieve the above purpose, a processing method of a brittle material is provided in the disclosure, which includes:
cutting, by a first laser on a workpiece to be processed, a contour line of a preset standard hole and a plurality of breaking guide line groups located within the range of the contour line, one end of a breaking guide line of the breaking guide line groups being connected with the contour line and the other end of the breaking guide line extending within the contour line;
heating and pre-breaking the contour line and the breaking guide line of the breaking guide line groups on the workpiece to be processed by a second laser;
processing a blanking hole within the contour line on the workpiece to be processed by a non-thermal processing, the extended end of the breaking guide line of the breaking guide line groups extending into the blanking hole; and
breaking along the contour line and the breaking guide line of the breaking guide line groups on the workpiece to be processed to form a standard hole in the workpiece to be processed.

In some embodiments, each of the breaking guide line groups includes two breaking guide lines, ends of the two breaking guide lines which are connected with the contour line are close to each other, and extended ends of the two breaking guide lines are away from each other.

In some embodiments, the breaking along the contour line and the breaking guide line of the breaking guide line groups on the workpiece to be processed includes:
rapidly cooling an area between the contour line and the two breaking guide lines of each of the breaking guide line groups on the workpiece to be processed, and pressurizing the area after a preset time to separate the area from the workpiece to be processed.

In some embodiments, the rapidly cooling the area between the contour line and the two breaking guide lines of each of the breaking guide line groups on the workpiece to be processed includes:
spraying quick cooling agent or low-temperature liquid nitrogen on the area between the contour line and the two breaking guide lines of each of the breaking guide line groups on the workpiece to be processed for quick cooling.

In some embodiments, the processing the blanking hole within the contour line on the workpiece to be processed by the non-thermal processing includes:
processing the blanking hole within the contour line on the workpiece to be processed by mechanical drilling.

In some embodiments, the processing the blanking hole within the contour line on the workpiece to be processed by the mechanical drilling includes:
spraying water within the contour line of the workpiece to be processed during the mechanical drilling.

In some embodiments, the mechanical drilling is electric drill drilling or machine tool drilling.

In some embodiments, the first laser is an infrared picosecond laser, an infrared femtosecond laser, a green picosecond laser, or a green femtosecond laser.

In some embodiments, the second laser is a CO₂ laser.

In some embodiments, the processing method of the brittle material further includes: cleaning a surface to be cut of the workpiece to be processed before the step of cutting the contour line of the preset standard hole and the plurality of breaking guide line groups located within the range of the contour line on the workpiece to be processed by the first laser.

Compared with the related art, the technical solution of the present disclosure has following beneficial effects:

In the processing method of the brittle materials according to the present disclosure, first, the contour line of the preset standard hole and the plurality of breaking guide line groups located within the range of the contour line are cut on the workpiece to be processed by the first laser, one end of the breaking guide line of the breaking guide line groups is connected with the contour line and the other end of the breaking guide line extends within the contour line; then the contour line and the breaking guide line of the breaking guide line groups on the workpiece to be processed are heated and pre-breaked by the second laser; the blanking hole is processed within the contour line on the workpiece to be processed by a non-thermal processing, the extended end of the breaking guide line of the breaking guide line groups extends into the blanking hole; and finally breaking is performed along the contour line and the breaking guide line of the breaking guide line groups on the workpiece to be processed to form the standard hole in the workpiece. According to the processing method of the brittle material, the breaking guide line which is cut earlier is not influenced by the chipping of the edge of the blanking hole which is processed later, and can well intersect and be connected with the contour line. Further, the contour line has certain external breaking shielding after being heated and pre-breaked, and because the blanking hole is not processed first, there's a large area within the contour line which can be used to release thermal breaking stress of the breaking guide line during the heating and pre-breaking, and thus the generated breaking guide line can be prevented from being outside the contour line, facilitating a successful subsequent breaking, with high product processing success rate.

### BRIEF DESCRIPTION OF THE DRAWINGS

FIG. 1 is a flowchart of a processing method of a brittle material according to an embodiment of the present disclosure;

FIG. 2 shows a processing sequence of processing a circular hole in a brittle material according to an embodiment of the present disclosure; and

FIG. 3 shows a processing sequence of processing a square hole in a brittle material according to an embodiment of the present disclosure.

Realization of the purposes, functional characteristics and advantages of the disclosure will be further explained in combination with embodiments and with reference to attached figures.

### DETAILED DESCRIPTION OF THE EMBODIMENTS

In the following, schemes in embodiments of the disclosure will be described clearly and completely in connection with the attached drawings of the embodiments of this disclosure; obviously, the described embodiments are only a part of the embodiments of the disclosure, but not all of them. On a basis of the embodiments in this disclosure, all other embodiments obtained by the ordinary skilled in the art without any creative effort are within the protection scope of this disclosure.

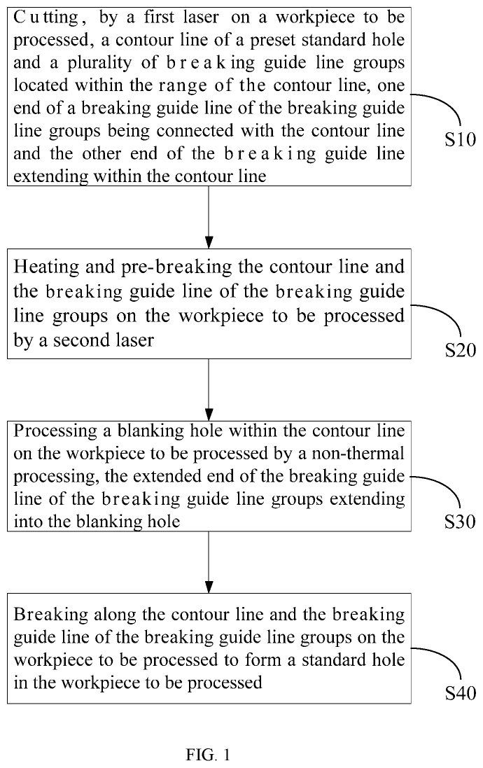

A processing method of a brittle material is provided in the disclosure, which, as shown in FIG. 1, includes steps S10 to S40.

In step S10, a contour line 1 of a preset standard hole 10 and a plurality of breaking guide line groups located within the contour line 1 are cut on a workpiece 100 to be processed by a first laser, one end of a breaking guide line 2 of the breaking guide line groups is connected with the contour line 1 and the other end of the breaking guide line extends within the contour line 1.

In step S20, the contour line 1 and the breaking guide line 2 of the breaking guide line groups on the workpiece 100 to be processed are heated and pre-breaked by a second laser.

In step S30, a blanking hole 20 is processed within the contour line 1 on the workpiece 100 to be processed by a non-thermal processing, the extended end of the breaking guide line 2 of the breaking guide line groups extends into the blanking hole 20.

In step S40, breaking is performed along the contour line 1 and the breaking guide line 2 of the breaking guide line groups on the workpiece 100 to be processed to form a standard hole 10 in the workpiece 100 to be processed.

This embodiment provides a processing method of a brittle material to process and form a hole in the brittle material. The brittle material may be glass, but is not limited to this, and it can also be other high-hardness brittle materials. In case the brittle material is glass, the glass can be thick glass with a thickness of not less than 4 mm, such as 4 mm, 5 mm, 6 mm, 7 mm or 8 mm, and hole processing on the glass with above thicknesses can be realized by adopting the processing method according to this disclosure. Moreover, the hole processed in the brittle material may be a circular hole or an irregular hole, and the irregular hole can be a hole other than the circular hole, such as a square hole and a diamond hole.

Processing the circular hole in glass are taken as an example.

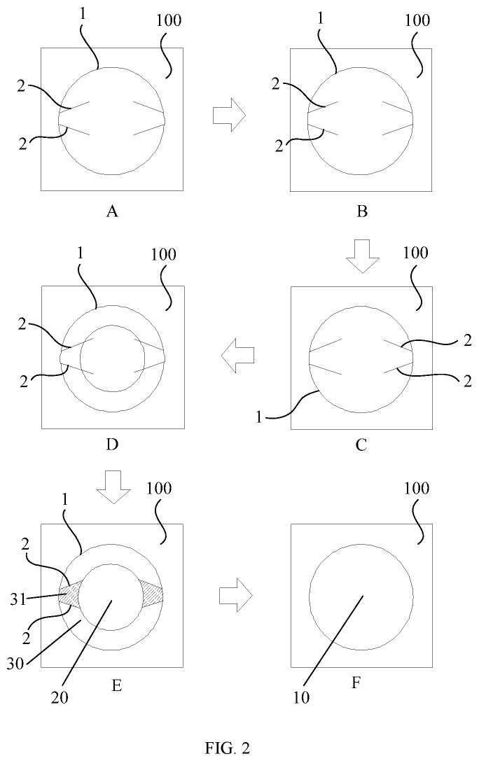

The step S10 is performed, in which a contour line 1 of a preset circular hole and a plurality of breaking guide line groups located within the contour line 1 are cut on the workpiece 100 to be processed by the first laser. A structure of the workpiece 100 to be processed in this step can be referred to a part A in FIG. 2. The number of breaking guide line groups can be set according to the number of sides of the standard hole 10, and the number of breaking guide lines 2 of the breaking guide line groups can be set according to actual situations. For the processing of the circular hole, there are two breaking guide line groups, which are opposite to each other, one end of a breaking guide line 2 of each of the two breaking guide line groups is connected with the contour line 1, and the other end of the breaking guide line extends within the contour line 1.

The step S20 is performed, in which the contour line 1 and the breaking guide line 2 of the breaking guide line groups on the workpiece 100 to be processed are heated and pre-breaked by the second laser. A structure of the workpiece 100 to be processed in this step can be referred to parts B and C in FIG. 2.

The step S30 is performed, in which a blanking hole 20 is processed within the contour line 1 on the workpiece 100 to be processed by a non-thermal processing, and the extended end of the breaking guide line 2 of the breaking guide line groups extends into the blanking hole 20. A structure of the workpiece 100 to be processed in this step can be referred to a part D in FIG. 2. The blanking hole 20 is smaller than the standard hole 10 in size, and is located in the circular hole. A breaking area 30 is defined between an edge line of the blanking hole 20 and the contour line 1 of the circular hole, and the breaking guide line 2 of the breaking guide line group is within the breaking area 30, with its extended end extending into the blanking hole 20. The blanking hole 20 may or may not correspond to the standard hole 10 in shape. For example, the blanking hole 20 is a circular hole corresponding to the standard hole 10.

The step S40 is performed, in which breaking is performed along the contour line 1 and the breaking guide line 2 of the breaking guide line groups on the workpiece 100 to be processed to form the circular hole in the workpiece 100 to be processed. A structure of the workpiece 100 to be processed in this step can be referred to parts E and F in FIG. 2.

Processing the square hole in glass are taken as an example.

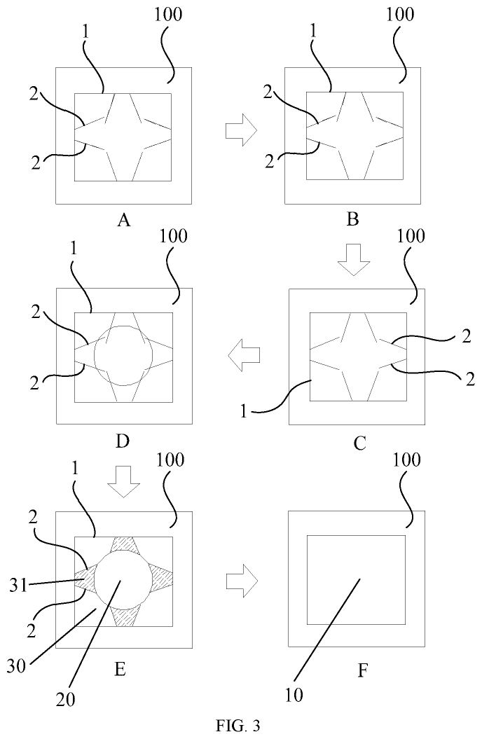

The step S10 is performed, in which a contour line 1 of a preset square hole and a plurality of breaking guide line groups located within the contour line 1 are cut on the workpiece 100 to be processed by the first laser. A structure of the workpiece 100 to be processed in this step can be referred to a part A in FIG. 3. A number of breaking guide line groups can be set according to a number of sides of the standard hole 10, and a number of breaking guide lines 2 of the breaking guide line groups can be set according to actual situations. For the processing of the square hole, there are four breaking guide line groups, which correspond to four sides of the square hole, one end of a breaking guide line 2 of each of the four breaking guide line groups is connected with the contour line 1, and the other end of the breaking guide line extends within the contour line 1.

The step S20 is performed, in which the contour line 1 and the breaking guide line groups on the workpiece 100 to be processed are heated and pre-breaked by the second laser to correspondingly generate the contour line 1 and the breaking guide line groups. A structure of the workpiece 100 to be processed in this step can be referred to parts B and C in FIG. 3.

The step S30 is performed, in which a blanking hole 20 is processed within the contour line 1 on the workpiece 100 to be processed by a non-thermal processing, the extended end of the breaking guide line 2 of the breaking guide line groups extends into the blanking hole 20. A structure of the workpiece 100 to be processed in this step can be referred to a part D in FIG. 3. The blanking hole 20 is smaller than the standard hole 10 in size, and is located in the square hole. A breaking area 30 is defined between an edge line of the blanking hole 20 and the contour line 1 of the square hole, and the breaking guide line 2 of the breaking guide line group is within the breaking area 30, with its extended end extending into the blanking hole 20. The blanking hole 20 may or may not correspond to the standard hole 10 in shape. For example, the blanking hole 20 is a circular hole not corresponding to the standard hole 10.

The step S40 is performed, in which breaking is performed along the contour line 1 and the breaking guide line groups on the workpiece 100 to be processed to form the square hole in the workpiece 100 to be processed. A structure of the workpiece 100 to be processed in this step can be referred to parts E and F in FIG. 3.

In step S10 of this embodiment, a hole shape and size of the standard hole 10 to be processed can be preset in a laser cutting system. The first laser is configured for cutting, and preferably an ultra-fast laser, such as an infrared laser or a green laser. The ultra-fast laser has short pulse time, high peak energy, less thermal influence in material processing, and higher cutting edge quality of brittle materials. Further, a laser cutting apparatus is preferably a laser cutting mechanism with a XYZ driving module and an ultra-fast laser. The ultra-fast laser is equipped with a Bessel cutting head to realize emission of the first laser, and a structural size and shape of the hole that can be processed by the laser cutting apparatus are not limited. A Bessel focused beam produced by the Bessel cutting head has a small diameter and long focal depth, and a brittle material cut by the Bessel focused beam has a small edge taper and good edge quality.

In the step S20 of this embodiment, when the breaking guide line 2 of the breaking guide line groups is heated, the breaking guide line 2 of the breaking guide line groups does not extend outside the contour line 1, but just intersects with it, so that subsequent breaking quality can be ensured. That is, when viewed from front and back sides of the glass, breaking guide lines of the breaking guide line groups all intersect with the contour line 1, and when an intersection line is viewed from an oblique side of the glass, a part of breaking guide lines 2 of the glass can be seen bright. The second laser is configured for heating, and preferably a CO₂ laser.

In the step S30 of this embodiment, the blanking hole 20 is processed within the contour line by the non-thermal processing, and the brittle material in the blanking hole 20 is blanked first, so that internal stress within the contour line 1 can be removed. There are many non-thermal machining methods, such as mechanical drilling and waterjet cutting, which can be selected according to actual situations. The blanking hole 20 processed by the non-thermal processing may not affect the previously generated breaking guide line 2, which can ensure breaking efficiency and breaking quality. However, if laser cutting and other thermal processing methods are used to process the blanking hole 20, a melt flow at an edge of the blanking hole 20 is prone to reflow and block the breaking guide line 2, then the breaking guide line 2 needs to be heated to be pre-breaked again, which affects the breaking efficiency and quality.

In the step S40 of this embodiment, there may be various methods of breaking, such as mechanically pressing the breaking area 30 to split the breaking area 30 along the contour line 1 and the breaking guide line 2, and the standard hole 10 is formed finally after the brittle material of the breaking area 30 is blanked. Of course, this is only exemplary but not limiting.

In this embodiment, in processes of laser cutting, laser heating, processing of the standard hole, breaking, etc., an area outside the contour line of the standard hole of the workpiece 100 to be processed is fixed. The first laser and the second laser can be integrated into one laser device or be in two separate laser devices, which can be selected according to actual situations.

Based on implementation of the steps S10 to S40, in the processing method of the brittle material, the breaking guide line 2 which is cut earlier is not influenced by the chipping of the edge of the blanking hole 20 which is processed later, and can well intersect and be engaged with the contour line 1. Further, the contour line 1 has certain external breaking shielding after being heated and pre-breaked, and because the blanking hole 20 is not processed first, there's a large area within the contour line which can be used to release thermal breaking stress of the breaking guide line 2 during the heating and pre-breaking, and thus the generated breaking guide line 2 can be prevented from being outside the contour line 1, facilitating a successful subsequent breaking, with high product processing success rate.

In some embodiments, each of the breaking guide line groups includes two breaking guide lines 2, ends of the two breaking guide lines 2 which are connected with the contour line 1 are close to each other, and extended ends of the two breaking guide lines 2 are away from each other. In this embodiment, referring to FIG. 2 and FIG. 3, the breaking guide line group consists of two breaking guide lines 2, which form a “V” shape. Ends of the two breaking guide lines 2 which are connected with the contour line 1 are close to each other, and extended ends of the two breaking guide lines 2 are away from each other. Subsequent formation of the blanking hole 20 can break the stress of the brittle material within the contour line 1, and the “V” shape formed by the two breaking guide lines 2 can make stress in an area between the two breaking guide lines 2 radially towards the blanking hole 20, which facilitates stress release during subsequent breaking, and blanking can be rapidly realized in a breaking process.

In some embodiments, the step in which the breaking is performed along the contour line 1 and the breaking guide line 2 of the breaking guide line groups on the workpiece 100 to be processed includes:
rapidly cooling an area between the contour line 1 and the two breaking guide lines 2 of each of the breaking guide line groups on the workpiece 100 to be processed, and pressurizing the area after a preset time to separate the area from the workpiece to be processed.

In this embodiment, by rapid cooling, the area (that is, a small pre-blanking area 31 as shown in FIGS. 2 and 3) between the contour line 1 and the two breaking guide lines 2 of each of the breaking guide line groups on the workpiece 100 to be processed gradually shrinks inward due to low temperature, while an area outside the contour line 1 gradually shrinks inward due to heat diffusion, so that the workpiece 100 to be processed splits at the contour line 1 and the two breaking guide lines 2 of each of the breaking guide line groups. Then, after a preset time (e.g., 3 to 6 seconds), the area (that is, the small pre-blanking area 31 shown in FIGS. 2 and 3) between the contour line 1 and the two breaking guide lines 2 of each of the breaking guide line groups on the workpiece 100 to be processed is pressurized, so that the brittle material within this area can be separated from the workpiece to be processed, and a remaining area of the breaking area 30 may fall directly and automatically due to gravity, thus completing the breaking. There are many ways to pressurize, such as knocking or high-pressure water impact, which includes but is not limited to this. In this embodiment, the brittle material can be split with high efficiency and high quality by means of rapid cooling and pressurizing.

In some embodiments, the step of rapidly cooling the area between the contour line 1 and the two breaking guide lines 2 of each of the breaking guide line groups on the workpiece 100 to be processed includes:
spraying quick cooling agent or low-temperature liquid nitrogen on the area between the contour line 1 and the two breaking guide lines 2 of each of the breaking guide line groups on the workpiece 100 to be processed for quick cooling.

In this embodiment, the area between the contour line 1 and the two breaking guide lines 2 of each of the breaking guide line groups on the workpiece 100 to be processed is rapidly cooled by spraying the quick cooling agent or low-temperature liquid nitrogen, which facilitates operation with a fast cooling speed. Of course, in addition, other preparations that can serve to quickly cool down can be used, which can be selected according to actual situations.

In some embodiments, the step in which the blanking hole 20 is processed within the contour line 1 on the workpiece 100 to be processed by the non-thermal processing includes:
processing the blanking hole 20 within the contour line 1 on the workpiece 100 to be processed by mechanical drilling.

In this embodiment, the blanking hole 20 processed by the mechanical drilling has small edge chipping and good smoothness.

In some embodiments, the step of processing the blanking hole 20 within the contour line 1 on the workpiece 100 to be processed by the mechanical drilling includes:
spraying water within the contour line 1 of the workpiece 100 to be processed during the mechanical drilling.

In this embodiment, during the mechanical drilling, heat is absorbed by sprayed water, which can ensure that the workpiece 100 to be processed is not heated up due to friction, avoids explosion of the workpiece 100 to be processed, and further improves product processing success rate. In addition, dust generated during the mechanical drilling can be washed away by spraying water, which ensures cleanliness of the surface of the workpiece 100 to be processed, facilitates subsequent breaking and improves breaking quality.

Further, the mechanical drilling is electric drill drilling or machine tool drilling. In this embodiment, the electric drill or the machine tool is adopted, which has good drilling effect and can be conveniently operated.

In some embodiments, the first laser is an infrared picosecond laser, an infrared femtosecond laser, a green picosecond laser, or a green femtosecond laser. In the step S10, an ultra-fast laser is used as the first laser, and specifically any one of an infrared picosecond laser, an infrared femtosecond laser, a green picosecond laser, and a green femtosecond laser can be adopted, and an edge of the standard hole 10 of the processed brittle material has almost no edge chipping, with good edge smoothness.

In some embodiments, the second laser is a CO₂ laser. In step S20, the CO₂ laser is used as the second laser, which has good heating and pre-breaking effect.

In some embodiments, the processing method of the brittle material further includes step S50 before the step S10.

In the step S50, a surface to be cut of the workpiece 100 to be processed is cleaned.

In this embodiment, by cleaning the surface to be cut of the workpiece 100 to be processed, the surface to be cut is free of dirt and dust, thus with no influence on cutting of the first laser, which ensures the cutting of contour line 1 and the breaking guide line 2 that penetrates the workpiece 100 to be processed, thus avoiding the edge chipping of the workpiece 100 to be processed during heating and pre-breakedting, and improving the blanking success rate and yield. For example, after the contour line 1 of the standard hole 10 and the breaking guide line groups are cut on the glass, the glass can be inspected. When viewed from a transparent side of the glass, if a semi-transparent line meets an upper surface and a lower surface of the glass without any breaks, it can be determined that the laser cutting penetrates the glass.

It should be noted that technical schemes of respective embodiments of the disclosure can be combined with each other, which must be based on enabling of realization by an ordinary skilled in the art. When combination of technical schemes is contradictory or impossible to be realized, it should be considered that such combination of technical schemes does not exist and either is not within the protection scope claimed in this disclosure.

The above is only a part or preferred embodiments of the disclosure, and neither the text nor the drawings can serve to limit the protection scope of the disclosure. Any equivalent structural transformation made under a concept integral with the disclosure using the specification and drawings of the present disclosure, which is directly or indirectly applied to other related technical fields, is included within the protection scope of the disclosure.

What is claimed is:

1. A processing method of a brittle material, comprising:
cutting, by a first laser on a workpiece to be processed, a contour line of a preset standard hole and a plurality of breaking guide line groups located within the range of the contour line, one end of a breaking guide line of the breaking guide line groups being connected with the contour line and the other end of the breaking guide line extending within the contour line;
heating and pre-breaking the contour line and the breaking guide line of the breaking guide line groups on the workpiece to be processed by a second laser;
processing a blanking hole within the range of the contour line on the workpiece to be processed by a non-thermal processing, the extended end of the breaking guide line of the breaking guide line groups extending into the blanking hole; and
breaking along the contour line and the breaking guide line of the breaking guide line groups on the workpiece to be processed to form a standard hole in the workpiece to be processed.

2. The processing method of the brittle material according to claim 1, wherein each of the breaking guide line groups comprises two breaking guide lines, ends of the two breaking guide lines which are connected with the contour line being close to each other and extended ends of the two breaking guide lines being away from each other.

3. The processing method of the brittle material according to claim 2, wherein the breaking along the contour line and the breaking guide line of the breaking guide line groups on the workpiece to be processed comprises:
rapidly cooling an area between the contour line and the two breaking guide lines of each of the breaking guide line groups on the workpiece to be processed, and pressurizing the area after a preset time to separate the area from the workpiece to be processed.

4. The processing method of the brittle material according to claim 3, wherein the rapidly cooling the area between the contour line and the two breaking guide lines of each of the breaking guide line groups on the workpiece to be processed comprises:
spraying quick cooling agent or low-temperature liquid nitrogen on the area between the contour line and the two breaking guide lines of each of the breaking guide line groups on the workpiece to be processed for quick cooling.

5. The processing method of the brittle material according to claim 1, wherein the processing the blanking hole within the contour line on the workpiece to be processed by the non-thermal processing comprises:
processing the blanking hole within the contour line on the workpiece to be processed by mechanical drilling.

6. The processing method of the brittle material according to claim 5, wherein the processing the blanking hole within the contour line on the workpiece to be processed by the mechanical drilling comprises:
spraying water within the contour line of the workpiece to be processed during the mechanical drilling.

7. The processing method of the brittle material according to claim 5, wherein the mechanical drilling is electric drill drilling or machine tool drilling.

8. The processing method of the brittle material according to claim 1, wherein the first laser is an infrared picosecond laser, an infrared femtosecond laser, a green picosecond laser, or a green femtosecond laser.

9. The processing method of the brittle material according to claim 1, wherein the second laser is a CO₂ laser.

10. The processing method of the brittle material according to claim 1, wherein before the step of cutting, by the first laser on the workpiece to be processed, the contour line of the preset standard hole and the plurality of breaking guide line groups located within the range of the contour line, the processing method further comprises:
cleaning a cutting surface of the workpiece to be processed.
